(19) United States
(12) Patent Application Publication
(10) Pub. No.: US 2024/0045892 A1
(43) Pub. Date: Feb. 8, 2024

(54) INTERFACING WITH PLANNED OPERATIONS OF AN AGGREGATED ASSISTANT

(71) Applicant: International Business Machines Corporation, Armonk, NY (US)

(72) Inventors: Kristina Marie Brimijoin, New York, NY (US); Shubham Agarwal, Cambridge, MA (US); Tathagata Chakraborti, Cambridge, MA (US); Aalim Lakhani, Toronto (CA); Scott Boag, Woburn, MA (US)

(21) Appl. No.: 17/817,024

(22) Filed: Aug. 3, 2022

(51) Int. Cl. G06F 16/332; G06F 16/33

(52) U.S. Cl. CPC G06F 16/3329; G06F 16/3344

(57) ABSTRACT

A computer system includes a display and a processing system. The processing system is configured to receive an input from a user using and to control an aggregated assistant interface displayed on the display. The aggregated assistant interface displays one or more planned operations in response to receiving an initial input from the user and is configured to receive one or more interactive inputs configured to interact with the planned operations.

### BACKGROUND

The present invention relates in general to computer-implemented artificial intelligent (AI) assistants, and more particularly, interfacing with planned operation of an aggregated assistant.

Conversational assistants (commonly found on smart phones and smart wearable devices, for example) have found increased user adoption over the last decade and are adept at performing tasks like setting a reminder or an alarm, putting in an order online, control a smart device, etc. With recent advances in AI and conversational assistants, a new design of an AI assistant referred to as an “aggregated assistant” has become increasingly popular. The architecture of an aggregated assistant is built out of individual components called “skills.” The skills define a unit of automation, which facilitate the performance of atomic tasks that can be composed together to build the assistant capable of performing more complex tasks.

### SUMMARY

One or more non-limiting embodiments of the invention include a computer-implemented method comprises generating and displaying an aggregated assistant interface using a processor system. The computer-implemented method further includes receiving an input from a user using the processor system, and controlling the aggregated assistant interface based at least in part on the input. According to a non-limiting embodiment, the aggregated assistant interface displays one or more planned operations in response to receiving an initial input from the user and is configured to receive one or more interactive inputs configured to interact with the planned operations.

Embodiments of the invention include a computer system and a computer program product having substantially the same features as the computer-implemented method described above.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts an architecture of an aggregated assistant 100 defined by an assistant-agent-skill hierarchy as implemented in a computing system 102 according to a non-limiting embodiment;

FIG. 2A depicts an aggregated assistant computing interface capable of interacting with an aggregated agent operating on a computer system is illustrated according to a non-limiting embodiment;

FIG. 2B depicts a display screen included in an aggregated assistant computing interface operating in the State View display mode according to a non-limiting embodiment;

FIG. 3 depicts a display screen included in an aggregated assistant computing interface operating in the Plan View display mode according to a non-limiting embodiment;

FIG. 4 illustrates an aggregated assistant interface performing a collaborative decision-making interaction with a user according to a non-limiting embodiment of the invention;

FIG. 5 illustrates an aggregated assistant interface performing a collaborative decision-making interaction with a user according to a non-limiting embodiment of the invention;

FIG. 6 depicts an aggregated assistant interface showing a system mistake occurring while an aggregated assistant performs a planning operation according to a non-limiting embodiment;

FIG. 7 illustrates a user interacting with the aggregated assistant interface shown in FIG. 6 to resolve the system mistake according to a non-limiting embodiment;

FIG. 8 illustrates a user interacting with the aggregated assistant interface shown in FIG. 6 to deselect a step included in the planning operation shown in FIG. 6 according to a non-limiting embodiment;

FIG. 9 illustrates a user interacting with the aggregated assistant interface shown in FIG. 6 to re-order steps included in the planning operation shown in FIG. 6 according to a non-limiting embodiment;

FIG. 10 depicts details of an exemplary programmable computer system capable of implementing aspects of the invention;

FIG. 11 depicts a cloud computing environment according to embodiments of the present invention; and

FIG. 12 depicts abstraction model layers according to an embodiment of the present invention.

In the accompanying figures and following detailed description of the disclosed embodiments, the various elements illustrated in the figures are provided with three-digit reference numbers. The leftmost digit of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are relevant to aspects of the invention, traditional conversational assistants remain quite limited to episodic tasks that mostly involve a single step and do not require maintaining and propagating state information across multiple steps. A key hurdle in the design of more sophisticate assistants is the complexity of the programming paradigm—at the end of the day, end-users and developers who are not necessarily subject matter experts have to be able to build and maintain these assistants.

Turning now to an overview of aspects of the invention, a computer system includes a processor system configured to generate and display an aggregated assistant interface, and receive one or more inputs from a user. The aggregated assistant interface displays one or more planned operations in response to receiving an initial input from the user and allows the user to interact with the planned operations. A planned operation is referred to herein as a sequence of “steps” where each step is represented by an “agent”. Embodiments of the invention also include a computer-implemented method and a computer program product having substantially the same features as the aforementioned compute computer. Accordingly, the aggregated assistant computing interface allows a user to interact with planned operations of an aggregated assistant to promote transparency of the inner working of the aggregated assistant to the user.

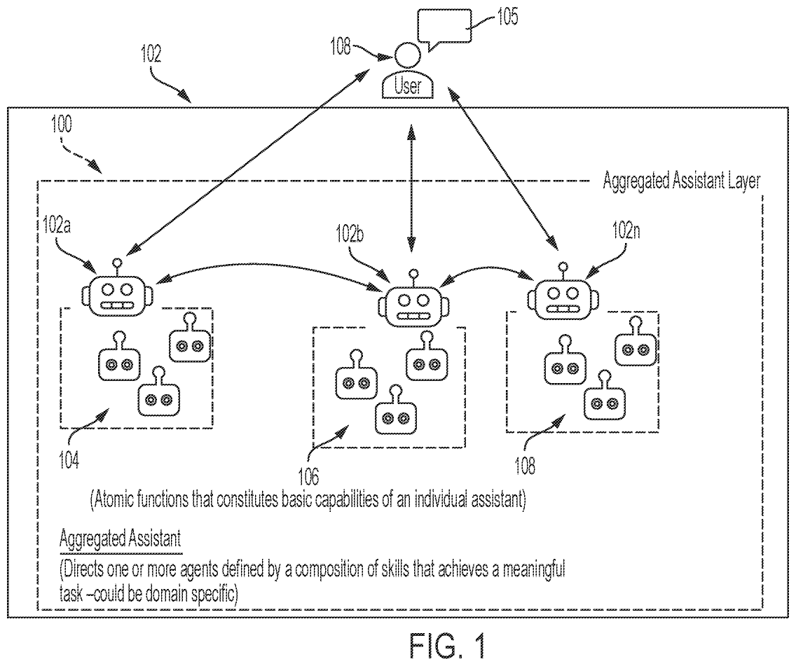

Turning now to a more detailed description of aspects of the invention, FIG. 1 depicts an architecture of an aggregated assistant 100 defined by an assistant-agent-skill hierarchy as implemented in a computing system 102 according to a non-limiting embodiment. The aggregated assistant 100 includes a plurality of individual agents 102a, 102b, 102n capable of exchanging data with one another. Each agent 102a, 102b, 102n includes one or more localized skills 104, 106, 108. The skills 104, 106, 108 can be grouped as an orchestrated skill set, where the skills within a given skill set operate as atomic functions that facilitate basic capabilities of their respective agent 102a, 102b, 102n. Accordingly, the aggregated agent 100 can receive one or more commands or inputs 105 from a user 108 (e.g., from an input device and/or spoken command) and direct one or more of the agents 102a, 102b, 102n to utilize their skills (e.g., perform their respective atomic functions) to achieve a meaningful task that satisfies the user's command(s).

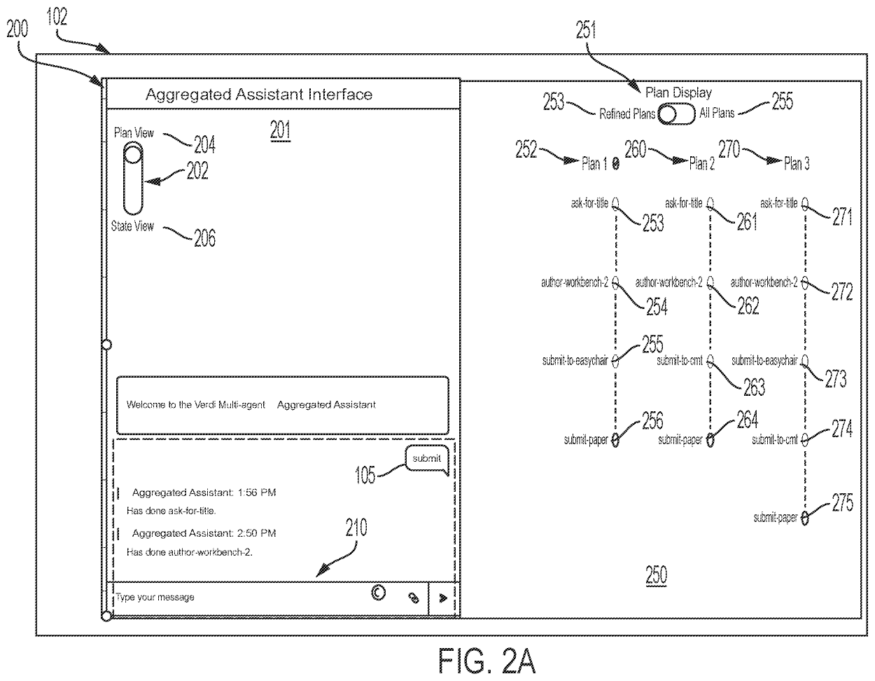

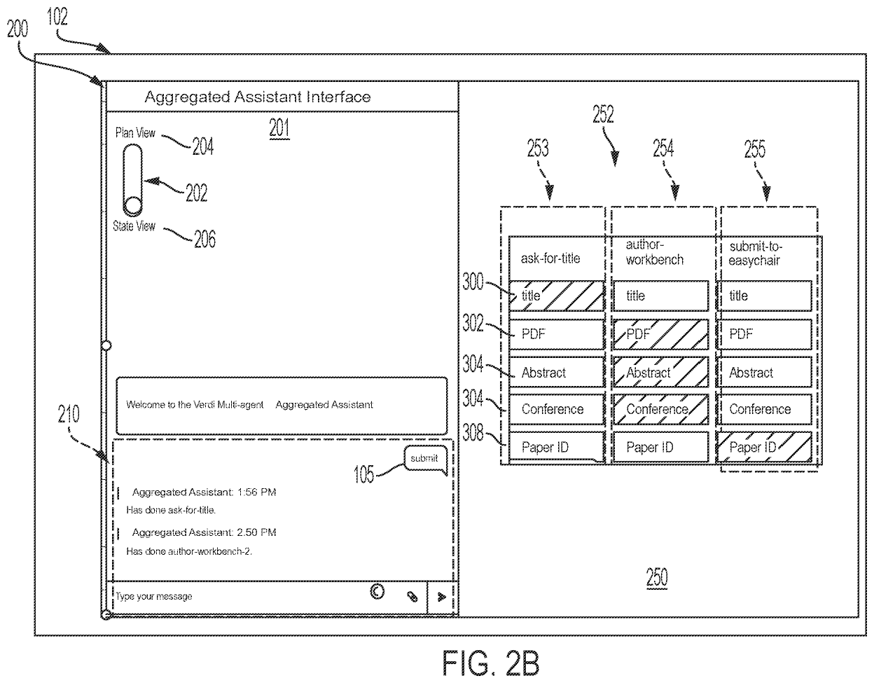

Turning now to FIGS. 2A and 2B, a computing interface 200 capable of interacting with an aggregated agent 100 operating on a computer system 102 is illustrated according to a non-limiting embodiment. As described herein, the computing interface 200 (also referred herein as an aggregated assistant interface) allows a user 108 to interact with planned operations of an aggregated assistant 100 to promote transparency of the inner working of the aggregated assistant 100 to the user 108.

The computing interface 200 includes an input screen 201 and a display screen 250. The input screen 201 receives one or more inputs 105 from a user 108 to control or select the information presented on the display screen 250. The input screen 201 includes a view selector 202 and an input section field 210. The view selector 202 can be manipulated by a user 108 to select a “Plan View” display mode 204 or a “State View” display mode 206 in order to cater towards users with different mental models and/or expertise. As described herein, a “plan” is a sequence of steps where, each step is represented by one or more “agents” in the “plan view” and by the state of the memory in the “state view”.

The Plan View display mode 204 is selected so that different planned operations (also simply referred to as “plans”) “Plan 1” 252, “Plan 2” 260 and “Plan 3” 270 are illustrated in the display screen 250. The user 108 may desire to select the Plan View display mode when a user model includes one or more agents (e.g., power user model or a debugger model). Accordingly, the Plan View display mode can display how the aggregated assistant 100 passes or exchanges data between the steps of a given planned operation 252, 260, 270.

The display screen 250 displays the information and/or interface controls corresponding to the display mode selected by the view selector 202. FIG. 2A depicts an example of the display screen 250 when the Plan View is selected. The Plan View displays one or more planned operations (e.g., “Plan 1” 252, “Plan 2” 260, “Plan 3” 270). Each planned operation 252, 260 and 270 includes the individual steps (e.g., 253-256, 261-264, 271-275) that define each planned operation 252, 260, 270.

In the example shown in FIG. 2A, the display screen 250 further displays a “Plan Display” control selector 251. The Plan Display control selector 251 allows the user 108 to select a “Refine Plans” mode 253 or an “All Plans” mode 255. The Refine Plans mode 253 presents the user 108 with reduced number of plans among the total planned operations available to the user 108, or can “filter” the number of planned operations presented the user 108. The particular planned operations that are displayed can be selected based on a confidence level or a relevancy determined by the aggregated assistant 100 to avoid overwhelming the user with less relevant planned operations.

FIG. 2B depicts an example of the display screen 250 when the State View display mode 206 is selected. Accordingly, the display screen 250 displays how each step facilitates the evolution of the global context or affects the overall outcome of the task. When the State View display mode 206 is selected, for example, the display screen 250 displays a given planned operation (e.g., “Plan 1” 252) as an arrangement of columns. Each column corresponds to a given step (e.g., 253, 254, 255) of the plan. Further each column displays the data relevant to a particular step. For example, the data relevant to the “ask for title” step is the “title” of a document. The data relevant to the “author-workbench” step is the pdf file name, conference name, document abstract name, and author names. The data relevant to the “submit to database” is author names, title of document, conference name, pdf file name, and abstract title. Accordingly, the user 108 can visually discern which information accessible by the aggregated assistant which visually displays a view of an evolution of a memory accessible by the processor system, and the type of information each agent of the aggregated assistant is obtaining and using to perform ongoing task to meet the user's input request 105. In one or more non-limiting embodiments, the aggregated assistant interface 200 overlays an inventory of data stored in memory. In this manner, the aggregated assistant interface 200 allows the user 108 to if the aggregated assistant's operations include a mistake. In one or more non-limiting embodiments described herein, the user 108 can further utilize the computing interface 200 to interrupt the aggregated assistant's operation with the goal of correcting the task.

The display screen 250 of the State View display mode 206 further includes a display indicator that indicates to the user 108 an inventory of data corresponding to a given step 252, 253, 254 is currently stored in memory or a database accessible by the computing system 102. For example, the indicator associated with the “title” data 300 included in the “ask-for-title” step 253 indicates to the user 108 that the title information input by the user 108 into the computing system matches data stored in memory or a database accessible by the user. Similarly, the indicators associated with the “PDF” data 302, the “Abstract” data 304, and the “Conference” data 306 indicates to the user 108 that a PDF document including an Abstract and associated with a conference is stored in memory or a database accessible by the user 108. The indictor associated with the “Paper ID” data 308 of the “submission to database” step 255 indicates to the user 108 that a research paper with a the corresponding “Paper ID” will be submitted to the named database.

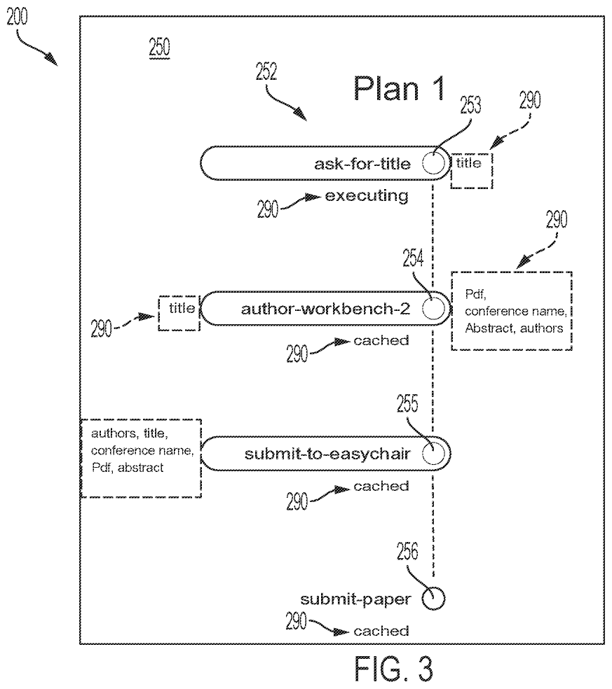

Referring to FIG. 3, the display screen 250 of the computing interface 200 is illustrated operating in the Plan View display mode 204 according to a non-limiting embodiment. In this example, the user 108 has submitted an interactive input 105 to select “Plan 1” 252 for execution. In one or more non-limiting embodiments, the aggregated assistant interface 200 is configured to display various overlay graphics 290 on the displayed planned operation 252. The overlay graphics 290 can be overlaid on the plan steps in response to a user's interaction with the computing interface 200. The overlay graphics 290 can include text boxes identifying a given agent and text-on-hover (ToH), which indicates what a given agent consumes and/or produces, and is displayed when a user interacts with the display agent (touches agent or hovers a pointer over a displayed agent). The ToH can also include text that is associated with a given agent (e.g., displayed beneath a given agent) that indicates the status of a given agent's ongoing execution while performing the planned operation. Accordingly, the user 108 can determine what information and/or data aggregated assistant is obtaining during each step of the planned operation 252

According to one or more non-limiting embodiments, the aggregated assistant interface 200 can modify the views of the planned operations based at least on one or more preferences input by user. The aggregated assistant interface 200 can also modify the views of the planned operations parts by hiding one or more visualized elements based on the user's selected preferences. The aggregated assistant interface 200 can also emphasized (e.g., highlight or graphically enhance) one or more visualized elements based on potential error or ambiguity or user interest.

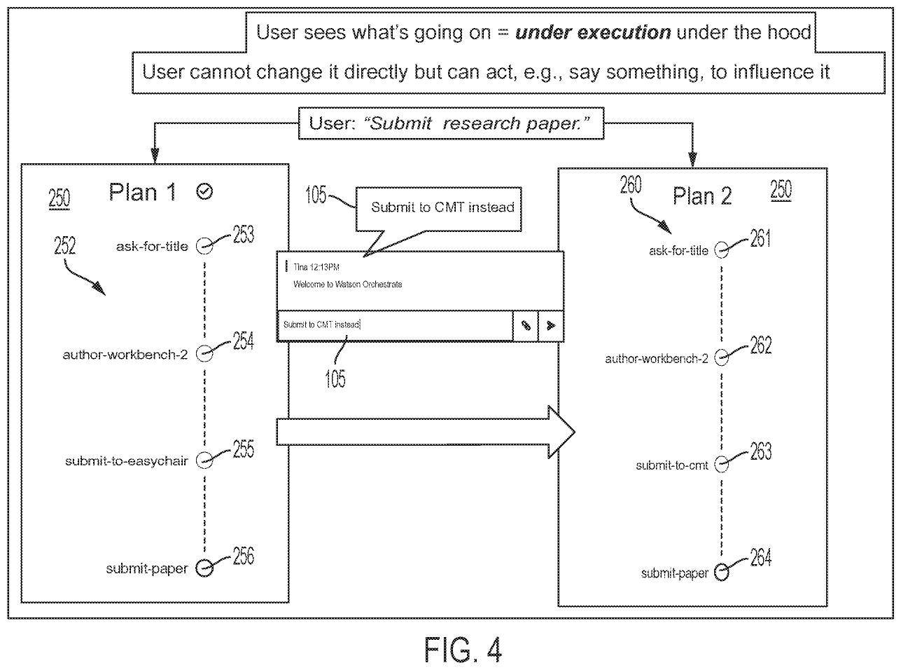

Turning now to FIG. 4, the aggregated assistant interface 200 is illustrated actively altering the executed planning operation in response to an interactive 105 received from the user 108. In this example, the user 108 may not directly change the plan but can influence it by submitting one or more inputs and/or verbal commands. As described herein, the aggregated assistant interface 200 allows the user 108 to view the process of the steps 253-256 as the aggregated assistant executes “Plan 1” 252. At step 255, for example, the user 108 can realize that the aggregated assistant interface 200 intends perform the requested submission of the research paper to an incorrect database (e.g., the “easychair” database) rather than a different intended database. Seeing the incorrect database at step 255, the user 108 can submit an interactive input 105 requesting that the aggregated assistant 100 submit the research paper to the intended database. In response to receiving the interactive input 105, the aggregated assistant 100 actively selects an alternative planning operation (e.g., “Plan 2” 260) for execution, which includes the intended database (e.g., the “CMT” database) at operation 263. In this manner, a mistake in the intended task (e.g. the submission of the user's research paper to the CMT database) can be avoided.

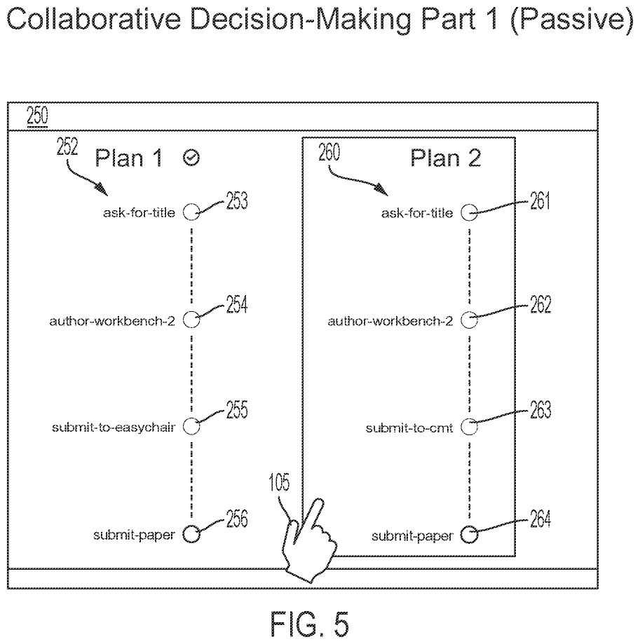

With reference now to FIG. 5, the aggregated assistant interface 200 is illustrated performing a collaborative decision-making interaction with a user 108 according to a non-limiting embodiment of the invention. In this example, the aggregated assistant interface 200 presents the user with an initial planning operation (e.g., “Plan 1” 252) as selected by the aggregated assistant 100, along with an alternative planning operation (e.g., “Plan 2” 260). As described herein, the user 108 can view the steps 253-256 of the initially selected planning operation 252 and the steps 261-264 of the alternative planning operation 260. Accordingly, the user can actively decide to submit an interactive input 105 (e.g., touch the alternative planning operation 260 shown on the display 250) so that the executed planning operation is changed from the initial planning operation 252 to the alternative planning operation 260.

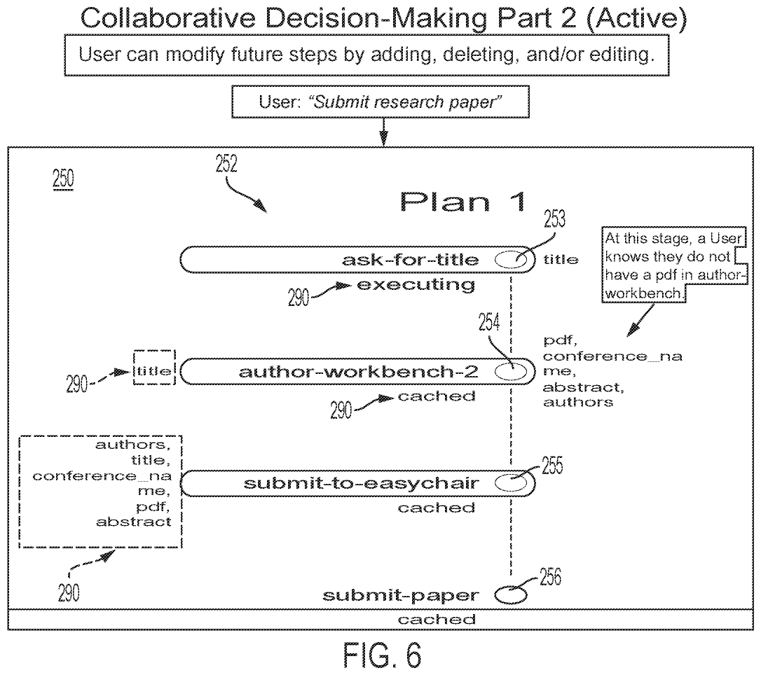

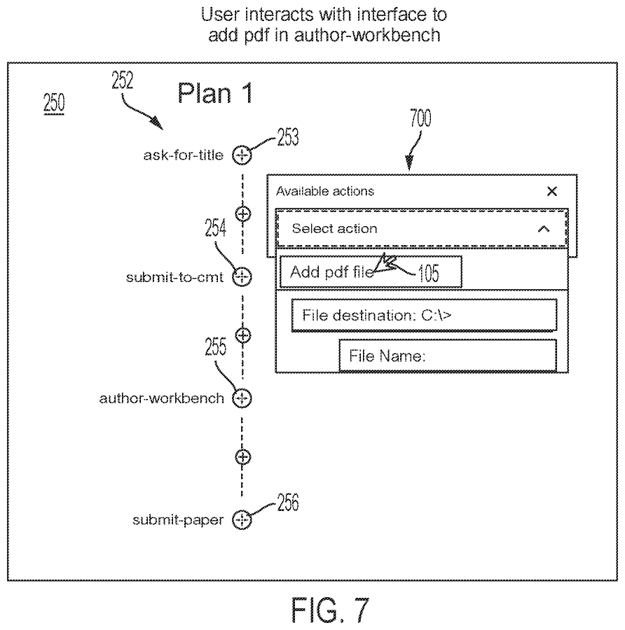

According to one or more non-limiting embodiments of the invention, the user 108 can refer to components of the aggregated assistant interface 200 in conversation (e.g. submit a verbal command) to modify the plan. For example, the aggregated assistant interface 200 allows a user 108 to submit one or more interactive inputs 105 for modifying a planned operation. FIGS. 6 and 7, for example, illustrate a process that allows a user 108 to add a step to a planned operation (e.g., “Plan 1” 252) presented on the display 250. At FIG. 6, the user 108 views the planned operation 252 shown on the display 250 notices that the aggregated assistant 100 intends to obtain a pdf file of the research paper at step 254 to satisfy the user's submission request. However, the user 108 realizes that a pdf file of the research paper is not included in memory or a database accessible by the computing system 102.

Turning to FIG. 7, the user 108 submits an interactive input 105 to select one or more available modification actions 700 for modifying the planned operation 252. The modification actions 700 include, but are not limited to, adding a step to the planned operation, deleting or deselecting a step from the planned operation, and editing a step included in the planned operation. In this example, the user 108 selects an action to add the missing pdf file. Accordingly, the user is presented with one or more data fields allowing the user to input the destination of the pdf file and the name of the pdf file to be obtained by the computing system 102.

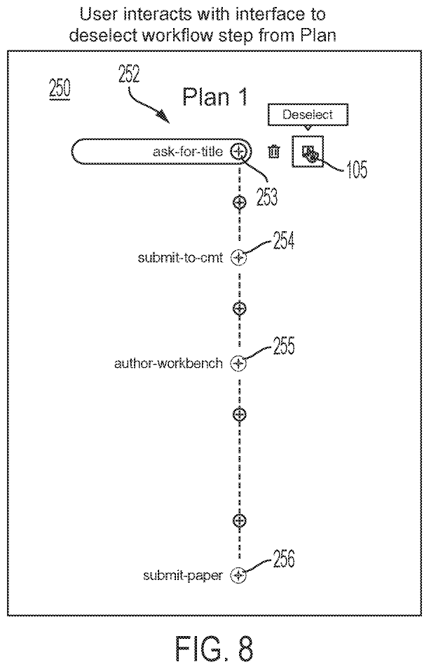

FIG. 8 illustrates another example of the user 108 modifying the planned operation 252. In FIG. 8, the user 108 submits an interactive input 105 to a delete or deselect a step (e.g., title input step 253) from the planning operation 252. In response to submitting interactive input 105, the selected step 253 is removed from the planned operation 252.

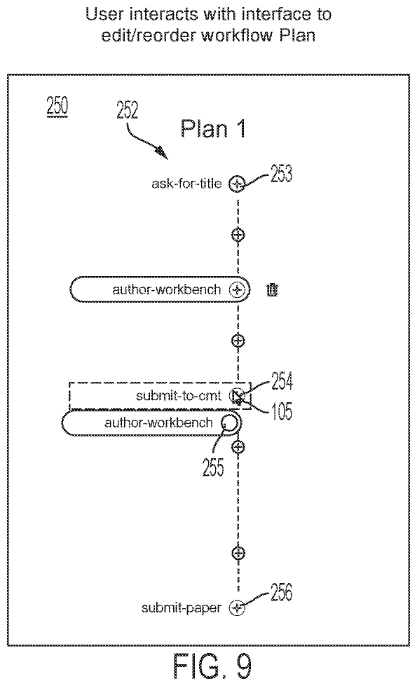

FIG. 9 illustrates another example of the user 108 modifying the planned operation 252, where a user 108 modifies the or reorders the workflow of the operating plan 252. In FIG. 9, the user 108 submits an interactive input 105 to swap the initial positions of steps 254 and 255. Accordingly, original step 254 (e.g., the author-workbench step) is moved down to step 255, and original step 255 (e.g., the database submission step) is moved up to step 254.

In one or more non-limiting embodiments of the invention, a user's interactive input 105 that confirms any of the modified planned operations described above causes the computing system to store the modified planned operation in memory for future use. In one or more non-limiting embodiments, the user's interaction with the aggregated assistant interface 200 can also be continuously monitored over time and stored memory. In this manner, the aggregated assistant 100 can learn the user's behavior patterns and manifest future planned operations based on the future inputs and behavior of the user 108.

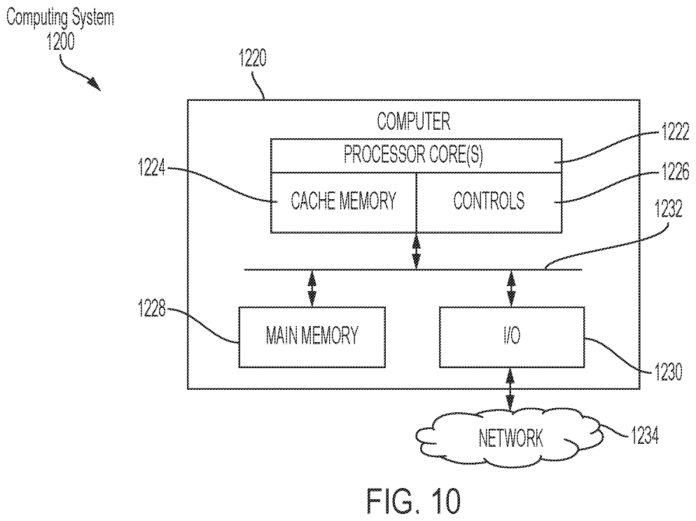

FIG. 10 illustrates an example of a computer system 1200 that can be used to implement the computer-based components of the neural network system described herein. The computer system 1200 includes an exemplary computing device (“computer”) 1202 configured for performing various aspects of the content-based semantic monitoring operations described herein in accordance aspects of the invention. In addition to computer 1202, exemplary computer system 1200 includes network 1214, which connects computer 1202 to additional systems (not depicted) and can include one or more wide area networks (WANs) and/or local area networks (LANs) such as the Internet, intranet(s), and/or wireless communication network(s). Computer 1202 and additional system are in communication via network 1214, e.g., to communicate data between them.

Exemplary computer 1202 includes processor cores 1204, main memory (“memory”) 1210, and input/output component(s) 1212, which are in communication via bus 1203. Processor cores 1204 includes cache memory (“cache”) 1206 and controls 1208, which include branch prediction structures and associated search, hit, detect and update logic, which will be described in more detail below. Cache 1206 can include multiple cache levels (not depicted) that are on or off-chip from processor 1204. Memory 1210 can include various data stored therein, e.g., instructions, software, routines, etc., which, e.g., can be transferred to/from cache 1206 by controls 1208 for execution by processor 1204. Input/output component(s) 1212 can include one or more components that facilitate local and/or remote input/output operations to/from computer 1202, such as a display, keyboard, modem, network adapter, etc. (not depicted).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

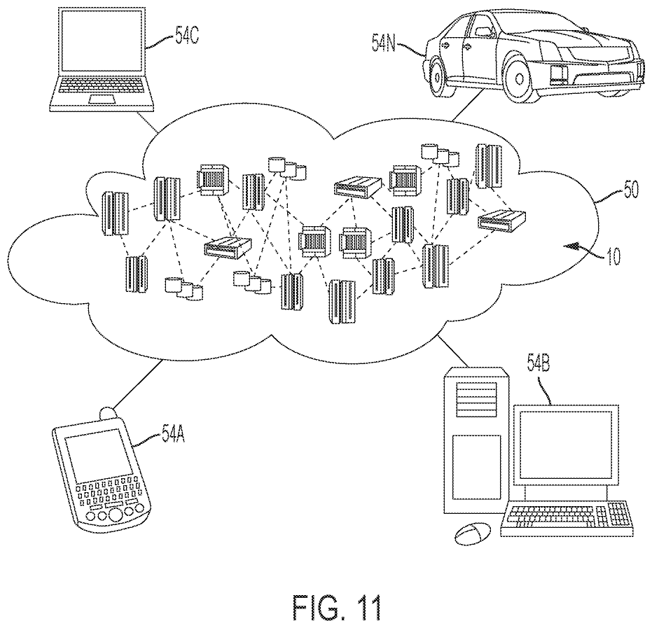

Referring now to FIG. 11, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

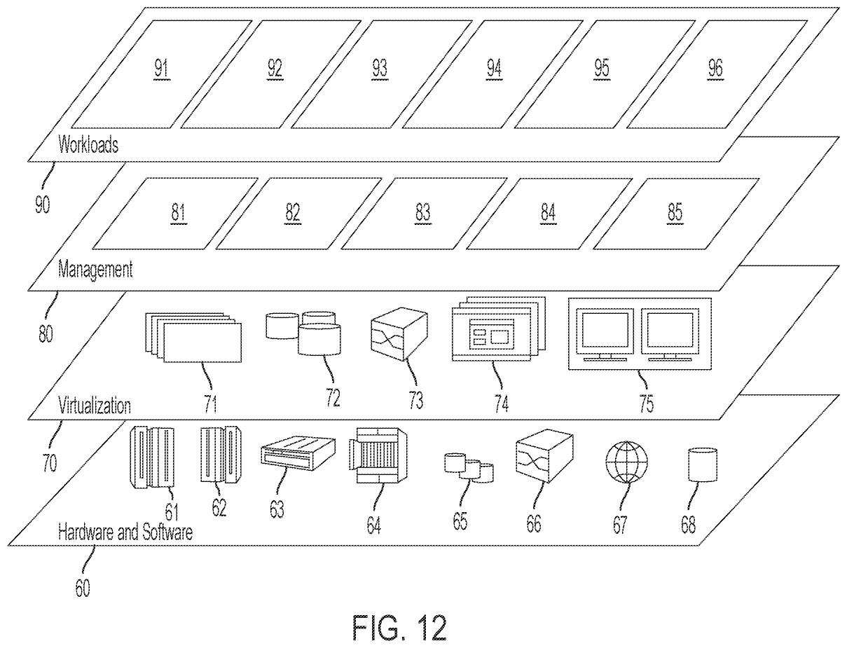

Referring now to FIG. 12, a set of functional abstraction layers provided by cloud computing environment 50 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the secure and reliable benefit-analysis matchmaking to select candidates for federated learning 96.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

Many of the functional units described in this specification are illustrated as logical blocks such as classifiers, modules, servers, processors, and the like. Embodiments of the invention apply to a wide variety of implementations of the logical blocks described herein. For example, a given logical block can be implemented as a hardware circuit operable to include custom VLSI circuits or gate arrays, as well as off-the-shelf semiconductors such as logic chips, transistors, or other discrete components. The logical blocks can also be implemented in programmable hardware devices such as field programmable gate arrays, programmable array logic, programmable logic devices, and the like. The logical blocks can also be implemented in software for execution by various types of processors. Some logical blocks described herein can be implemented as one or more physical or logical blocks of computer instructions which can, for instance, be organized as an object, procedure, or function. The executables of a logical block described herein need not be physically located together but can include disparate instructions stored in different locations which, when joined logically together, include the logical block and achieve the stated purpose for the logical block.

Many of the functional units of the systems described in this specification have been labeled as models. Embodiments of the invention apply to a wide variety of model implementations. For example, the models described herein can be implemented by machine learning algorithms and natural language processing algorithms configured and arranged to uncover unknown relationships between data/information and generate a model that applies the uncovered relationship to new data/information in order to perform an assigned task of the model.

The various components, modules, sub-function, and the like of the systems illustrated herein are depicted separately for ease of illustration and explanation. In embodiments of the invention, the operations performed by the various components, modules, sub-functions, and the like can be distributed differently than shown without departing from the scope of the various embodiments of the invention described herein unless it is specifically stated otherwise.

For convenience, some of the technical operations described herein are conveyed using informal expressions. For example, a processor that has key data stored in its cache memory can be described as the processor “knowing” the key data. Similarly, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding more formal and technical description.

Embodiments of the invention utilize various types of artificial neural networks, which are modeled after the functionality of biological neurons in the human brain. In general, a biological neuron has pathways that connect it to upstream inputs, downstream outputs, and downstream “other” neurons. Each biological neuron sends and receives electrical impulses through pathways. The nature of these electrical impulses and how they are processed in the biological neuron are primarily responsible for overall brain functionality. The pathway connections between the biological neurons can be strong or weak. When the neuron receives input impulses, the neuron processes the input according to the neuron's function and sends the result of the function on a pathway to downstream outputs and/or on a pathway to downstream “other” neurons. A normal adult human brain includes about one hundred billion interconnected neurons.

In artificial neural networks, the biological neuron is modeled as a node having a mathematical function, f(x). Each node in the neural network receives electrical signals from inputs over one of multiple pathways, multiplies each input by the strength of its respective connection pathway, takes a sum of the inputs, passes the sum through a function (f(x)) of the node, and generates a result, which may be a final output or an input to another node, or both. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

In general, neural networks can be implemented as a set of algorithms (e.g., machine learning algorithms) running on a programmable computer (e.g., computer systems 1200 shown in FIG. 10). In some instances, neural networks are implemented on an electronic neuromorphic machine that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network creates a “model” that is “trained” by performing multiple iterations of learning-based analysis on the real-world data vectors until patterns (or relationships) contained in the real-world data vectors are uncovered and learned. The patterns uncovered/learned by the model of the neural network can be used to perform a variety of tasks. The learning or training performed by the machine learning algorithms on the model can be supervised, unsupervised, or a hybrid that includes aspects of supervised and unsupervised learning. Supervised learning is when training data is already available and classified/labeled. Unsupervised learning is when training data is not classified/labeled so must be developed through iterations of the neural network and the machine learning algorithms. Unsupervised learning can utilize additional learning/training methods including, for example, clustering, anomaly detection, neural networks, deep learning, and the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating and displaying an aggregated assistant interface using a processor system; and
receiving an input from a user using the processor system,
wherein the aggregated assistant interface displays one or more planned operations in response to receiving an initial input from the user and is configured to receive one or more interactive inputs configured to interact with the planned operations.

2. The computer-implemented method of claim 1, wherein the aggregated assistant interface includes a plurality of individual agents configured to perform respective atomic functions.

3. The computer-implemented method of claim 2, wherein the respective atomic functions of each of the individual agents are different from one another.

4. The computer-implemented method of claim 3, wherein the system can select different display modes.

5. The computer-implemented method of claim 4, wherein the different display modes include a plan view display mode and state view display mode.

6. The computer-implemented method of claim 5, wherein the state view display mode displays a view of an evolution of a memory as the processor system controls the individual agents to execute the planned operations.

7. The computer-implemented method of claim 6, wherein the view of the evolution includes a global context as shared by the plurality of individual agents.

8. The computer-implemented method of claim 5, wherein the plan view display mode displays a plurality of different one or more planned operations in response to the initial input, each of the planned operations including a plurality of steps for performing a task corresponding to the initial input.

9. The computer-implemented method of claim 8, wherein the interactive input is configured to select a preferred planned operation to perform the task or an alternative planned operation to avoid a potential failure in performing the task.

10. The computer-implemented method of claim 9, wherein the aggregated assistant interface displays a graphic identifier with the one or more of the planned operations to indicate differences among the one or more planned operations.

11. The computer-implemented method of claim 10, wherein a status of execution of a given planned operation among the one or more planned operations is overlaid on the steps.

12. The computer-implemented method of claim 11, wherein the aggregated assistant interface overlays an inventory of data stored in memory in response to selecting a given step included in the plan.

13. The computer-implemented method of claim 8, wherein the one or more interactive inputs are configured to modify the one or more planned operations.

14. The computer-implemented method of claim 13, wherein the user can refer to components of the aggregated assistant interface in conversation to modify the plan.

15. The computer-implemented method of claim 13, wherein modifying the planned operation include one or all of adding a step to the plan operation, deleting a step from the planned operation, and editing a step included in the planned operation.

16. The computer-implemented method of claim 15, wherein the one or more interactive inputs confirms the modified planned operation, and wherein confirming the modified planned operation stores the planned operation in memory for future use.

17. The computer-implemented method of claim 16, wherein the user interaction with the interface is stored to manifest in future planned behaviors.

18. A computer system comprising:
a display; and
a processing system configured to receive an input from a user using and to control an aggregated assistant interface displayed on the display,
wherein the aggregated assistant interface displays one or more planned operations in response to receiving an initial input from the user and is configured to receive one or more interactive inputs configured to interact with the planned operations.

19. The computer system of claim 18, wherein the aggregated assistant interface includes a plurality of individual agents configured to perform respective atomic functions.

20. A computer program product to operate processing system to control an aggregated assistant interface, the computer program product comprising a computer readable storage medium having program instructions embodied therewith, the program instructions executable by an electronic computer processor to control the processing system to perform operations comprising:
generate and display the aggregated assistant interface;
receive an input from a user; and
display, on the aggregated assistant interface, one or more planned operations in response to receiving an initial input from the user and is configured to receive one or more interactive inputs configured to interact with the planned operations,
wherein the aggregated assistant interface includes a plurality of individual agents configured to perform respective atomic functions.
